(19) United States
(12) Patent Application Publication
(10) Pub. No.: US 2012/0037039 A1
(43) Pub. Date: Feb. 16, 2012

(54) PULLULAN REPLACEMENTS FOR FILMS AND COATINGS

(75) Inventor: Marceliano B. Nieto, Abingdon, MD (US)

(73) Assignee: TIC GUMS, INC., Belcamp, MD (US)

(21) Appl. No.: 13/208,055

(22) Filed: Aug. 11, 2011

Related U.S. Application Data
(60) Provisional application No. 61/372,728, filed on Aug. 11, 2010.

(51) Int. Cl. C09D 101/02; C09D 197/02; C09D 103/00; C09D 105/06; C09D 105/04

(52) U.S. Cl. 106/162.5; 106/205.01; 106/205.72; 106/205.4

(57) ABSTRACT

This disclosure relates generally to materials configured to replace pullulan and pullulan functionalities and their use in applications such as edible films, coatings, breath or flavor strips, tablet coatings, gel caps, tobacco products, films for cheese or spice flavor delivery, films as barriers in food products, and non food products including industrial, personal care and pharmaceutical products. In addition, the materials and methods disclosed herein are configured for use in similar products that do not incorporate pullulan but would benefit from pullulan-like properties and functionalities.

### CROSS-REFERENCE TO RELATED APPLICATIONS

This application claims priority to U.S. Provisional Patent Application No. 61/372,728, filed Aug. 11, 2010, which is incorporated herein in its entirety.

### BACKGROUND

Pullulan was first used in breath films and this is still likely the largest application for this gum polysaccharide at the present time. In addition, pullulan is also used as a coating for tablets and has been successfully used to replace gelatin in gel capsules with the same heat sealing properties as gelatin. Pullulan achieved its GRAS status in 2002.

Pullulan is a water-soluble, extracellular polysaccharide produced by certain strains of the polymorphic fungus Aureobasidium pullulans, formerly known as Pullularia pullulans. The basic structure of pullulan was elucidated from the works of several researchers showing that it is a linear polymer of maltotriose subunits (glucose joined by α-(1→4) linkages) connected via α-(1→6) glycosidic linkages. Subsequently, it was established that there is a minor percentage of randomly-distributed maltotetraose subunits and these subunits were also joined by α-(1→6) linkages. The regular occurrence of α-(1→6) linkages kinks the structure of pullulan and interrupts what would otherwise be a linear starch amylose chain structure. The unique pattern of α-(1→6) linkages between maltotriose subunits gives the pullulan polymer distinctive physical properties, such as structural flexibility and high water solubility, resulting in distinct film- and fiber-forming characteristics such as: oxygen impermeability, edibility, biodegradability, and high solubility in water.

Pullulan, however, is expensive and cost restrictive compared to many other gum polymers. This high cost places significant economic and practical limits on its use. Certain prior art non-pullulan gum films, even at low concentrations or low film thicknesses, have the tendency to thicken the saliva, while still other prior art non-pullulan gum films tend to dissolve too slowly or not dissolve at all. These are unacceptable attributes and therefore, these prior art gums will not work as a replacement for pullulan. Certain commercial prior art pullulans, when dissolved at 25% w/w in water, have a viscosity at 20 RPM of 16,000-22,000 cP, are soluble in cold water, and produce a clear film that dissolves readily in the mouth with minimal thickening of the saliva. Further, many non-pullulan gum polysaccharides such as the standard grades of carboxymethylcellulose (CMC), methylcellulose, other cellulose derivatives, alginate, carrageenan, pectin, xanthan, etc., produce strong films at low gum concentrations but they are limited by their higher viscosity and, hence, they cannot be used at the same concentration as pullulan to achieve the same solids in a slurry prior to casting. Similarly, texture, mouthfeel, and rigidity differ between pullulan and other prior art non-pullulan materials, such as, gum polysaccharides.

As such, there is a need for a lower cost material with similar properties and functionalities as pullulan. The materials and methods disclosed herein provide a low cost solution to the problems described above.

### SUMMARY

The disclosure herein relates generally to materials configured for use as pullulan replacements and their use in various applications such as breath films, films for drug delivery, and other edible films and coating applications. The materials and methods disclosed herein are configured to mirror the properties and functionalities of pullulan, without incurring the high cost and while avoiding one or more of the disadvantages or prior art materials. For example, in one embodiment, the material disclosed herein comprises a film forming material and one or more of soluble filler, standardizing, or texture altering ingredients, wherein the material is blended such that its properties and functionalities are similar to pullulan.

### BRIEF DESCRIPTION OF THE DRAWING

FIG. 1 shows pictures of the pullulan control film and Replacements C & D.

### DETAILED DESCRIPTION

One aspect of the invention is a material that can replace some or all of pullulan's unique properties and functionalities. Thus, any given embodiment of the invention may not necessarily replace all of pullulan's functionalities in a given application, but would be an improvement in at least one functional area normally recognized as being a defining characteristic or particular advantage of pullulan. For example, the invention may provide a replacement for pullulan by mimicking functionalities such as tensile strength, clarity, solubility of an initial product, solubility of the end use application product, texture, viscosity, oxygen impermeability, edibility, biodegradability, high water solubility, or similar properties. For example, the invention may have different solubility or clarity compared to pullulan while matching other properties, such as tensile strength or viscosity.

A further aspect of the invention includes novel methods of preparing or physically modifying blended materials to produce unique properties and functionalities. Thus, where one aspect of the invention calls for mirroring, at least one aspect, of pullulan, also disclosed are materials with unique properties created by preparing, physically modifying, and/or blending starting materials to produce unique properties and functionalities.

For example, in one embodiment, when the materials are incorporated into a final product, the solubility of the final product is similar to, or improves upon, the solubility of the same final product containing pullulan.

The material of the invention may be used in such applications as breath or flavor strips, tablet coatings, gel caps, tobacco products, films for cheese or spice flavor delivery, films as barriers in food products, non-food products including industrial, personal care, and pharmaceutical products.

Certain commercial prior art pullulans, when dissolved at 25% w/w in water, have a viscosity at 20 RPM of 16,000-22,000 cP, are soluble in cold water, and produce a clear film that dissolves readily in the mouth with minimal thickening of the saliva. Many other gum polysaccharides such as the standard grades of carboxymethylcellulose (CMC), methylcellulose, other cellulose derivatives, alginate, carrageenan, pectin, xanthan, etc., produce stronger films at much lower gum concentrations but they are limited by their higher viscosity and, hence, they cannot be used at the same concentration as pullulan to achieve the same solids in a slurry prior to casting. Similarly, texture, mouthfeel, and rigidity differ between pullulan and other prior art non-pullulan materials, such as, gum polysaccharides. As such, the materials of the invention include additional ingredients in order to overcome these deficiencies. For example, certain embodiments include fillers, standardizing, or texture-altering ingredients, blended in certain concentrations, to the main film forming materials to achieve properties and functionalities similar or equivalent to pullulan.

By way of non-limiting example, pullulan Replacement A comprises a main film forming material comprising approximately from about 1.5% to about 60% of a gum, such as cellulose gum, methylcellulose, other cellulose derivatives, alginate, propylene glycol alginace, xanthan gum, pectin, carrageenan, starch or a blend or combination thereof; and about 15% to about 75% of soluble filler and/or texture altering ingredient(s) comprising of a monosaccharide, disaccharide, oligosaccharide, dextrins, low viscosity gums such as gum arabic, inulin, larch, or a blend or combination thereof. Among other properties, this combination serves to weaken the film creating a material with strength similar to that of the pullulan film.

As another example, pullulan Replacement B, a sugar free version, comprises a main film forming material approximately from about 1.5% to about 60% of a gum such as cellulose gum, methylcellulose, alginate, propylene glycol alginate, xanthan gum, pectin, carrageenan, or a blend or combination thereof; and about 15% to about 75% of soluble fillers and/or film texture altering ingredients comprising of a sugar alcohol [for example, maltitol, sorbitol, xylitol, mannitol, erythritol, etc.], and/or low viscosity gums such as gum arabic, inulin, larch, or a blend or combination thereof. This combination serves to weaken the film creating a material with, among other features, a strength similar to that of the pullulan film

A further example, pullulan Replacement C, comprises a main film forming material comprising approximately from about 50% to about 98% of a gum, such as low viscosity cellulose gum, methylcellulose, hydroxypropylmethylcellulose and other cellulose derivatives, a low viscosity guar gum, alginate, propylene glycol alginate, xanthan gum, pectin, carrageenan, starch or a blend or combination thereof; and about 1.5% to about 60% of soluble fillers, standardizing and/or texture altering ingredients comprising of a sugar and sugar equivalent caloric ingredients such as a monosaccharide, disaccharide, oligosaccharide, dextrins, starch hydrolyzate or a blend or combination thereof. This combination creates materials with, among other features, viscosity, tensile strength, solubility, and sensory properties optimized to mirror pullulan properties and functionalities. In one particular embodiment, the material comprises about 96% hydroxypropylmethlycellulose (HPMC) about 3% CMC and about 1% maltodextrin.

As another example, pullulan Replacement D, a sugar free version, comprises a main film forming material approximately from about 50% to about 98% of a gum such as low viscosity cellulose gum, methylcellulose, hydroxypropylmethylcellulose and other cellulose derivatives, low viscosity guar gum, alginate, propylene glycol alginate, xanthan gum, pectin, carrageenan, or a blend or combination thereof; and about 1.5% to about 60% of sugar-free soluble fillers, standardizing and/or texture altering ingredients comprising of a sugar alcohol [for example, maltitol, sorbitol, xylitol, mannitol, erythritol, etc.], and/or low viscosity gums such as gum arabic, inulin, larch, arabinoxylan, hydrolyzed guar, resistant maltodextrin, or a blend or combination thereof. This combination creates materials with, among other features, viscosity, tensile strength, solubility, and sensory properties optimized to mirror the properties and functionalities of pullulan. For example, one embodiment comprises about 94% HPMC, about 1% CMC, and about 5% low viscosity guar.

In a further aspect of the invention, the materials may include anti-foaming ingredient. This will ensure that the materials disclosed herein have foaming characteristics similar to pullulan. For example, any of the Replacements A-D may also include an anti-foaming ingredient.

As shown in Table 1, the viscosity of pullulan can be matched by proper selection and blending of the gum and non-gum components disclosed herein. For example, both pullulan Replacements C & D matched the viscosity of the pullulan control of approximately 18,000 cP average at 25% concentration [w/w in water]. Viscosity is one critical factor in casting because it affects the uniformity and evenness of the cast, and influences the mouthfeel of the finished film when it dissolves in the mouth. As mentioned, certain prior art non-pullulan gum films, even at much lower concentrations or lower film thicknesses, have the tendency to thicken the saliva, while still other prior art non-pullulan gum films tend to dissolve too slowly or not dissolve at all. These are unacceptable attributes for a film and coating and therefore, these prior art gums will not work as a replacement for pullulan, unlike the blended compositions disclosed herein.

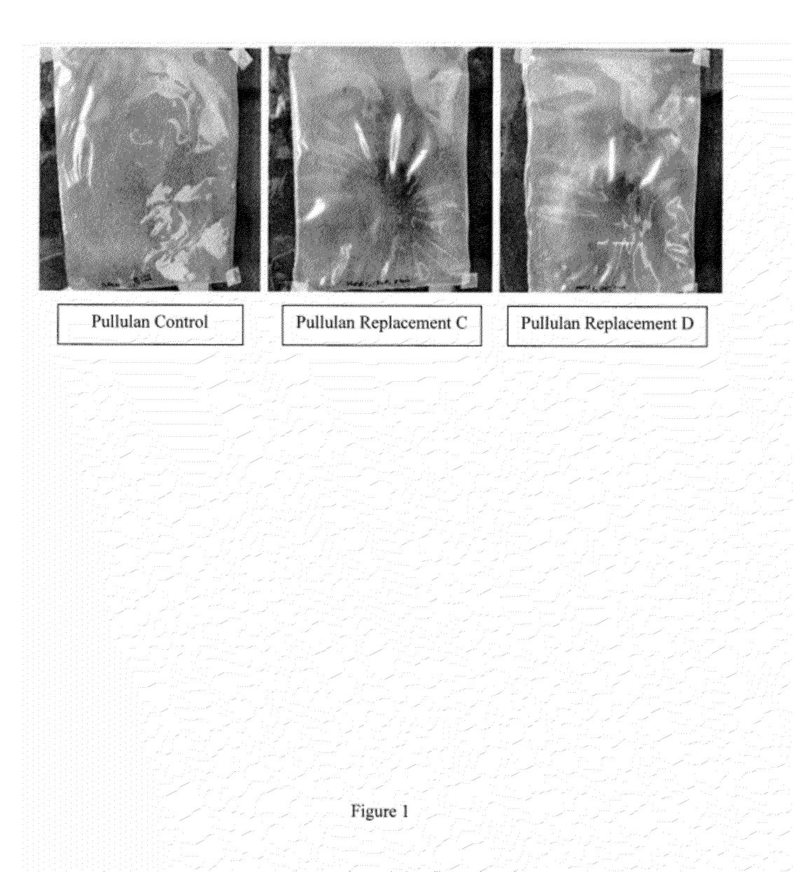

FIG. 1 shows pictures of the pullulan control film and Replacements C & D. The 25% solution of Replacements C & D both have a light yellow tinge in contrast to the pullulan control, which was water clear, however, their finished films are very comparable to the control in color and clarity. These exemplary films were made using the Mathis LabCoater/Dryer where the solution was cast at 20 mils [0.51 mm] and dried using a 2-stage drying process first at 130° F. and then at 175° F. However, without deviating from the invention, other techniques known to those of skill in the art could also be used to prepare the materials disclosed herein.

Table 2 compares the tensile strengths of certain examples of the materials disclosed herein and a pullulan control, measured longitudinally [along the direction of the cast] and transversally [across the cast] using the TA-XTP^{plus} Texture Analyzer on a 1″×4″ [2.54 cm×10.16 cm] strip of film. These results demonstrate that embodiments such as Replacements C & D match the tensile strength of the pullulan of about 13,000 g of force.

Table 3 compares the dissolution of the pullulan control film and certain examples of the materials disclosed herein. Strips of each material, measuring 25 mm×25 mm, were placed in 100 ml of water and stirred using a magnetic stir bar. As shown, the dissolution times for Replacements C & D are similar to the pullulan control. The sensory results in Table 4 also demonstrate that the attributes of the materials disclosed herein, such as thickness, mouth coating, and disintegration in the saliva were the same as control, while taste demonstrated only a slight deviation. Table 5 further shows the similarities between the viscosity of pullulan and the materials disclosed herein.

TABLE 1
Viscosity of pullulan and pullulan replacements at 25% concentration.

| | Average Viscosity, cP |
|---|---|
| Pullulan Control | 18000 |
| Pullulan Replacement C | 18300 |
| Pullulan Replacement D | 18500 |

TABLE 2
Tensile strengths of pullulan control and the pullulan replacement films.
All were 25% solution cast at thickness of 20 mils [0.51 mm]

| Pullulan Control | g Force | Pullulan Control | g Force |
|---|---|---|---|
| Longitude 1 | 14784.7 | Transverse 1 | 12027.8 |
| Longitude 2 | 14704.2 | Transverse 2 | 11846.8 |
| Longitude 3 | 12676.6 | Transverse 3 | 12951.6 |
| Longitude 4 | 13274.9 | Transverse 4 | 15206.3 |
| Average | 13860.1 | Average | 13008.1 |
| S.D. | 1050.5 | S.D. | 1543.3 |
| Pullulan Replacement C, | | Pullulan Replacement C, | |
| Batch 1 | | Batch 1 | |
| Longitude 1 | 11169.3 | Transverse 1 | 12670.7 |
| Longitude 2 | 13744.2 | Transverse 2 | 12309.3 |
| Longitude 3 | 12054.3 | Transverse 3 | 11955.6 |
| Longitude 4 | 12891.5 | Transverse 4 | 16894.4 |
| Average | 12464.8 | Average | 13457.5 |
| S.D. | 1105.4 | S.D. | 2309.8 |
| Pullulan Replacement C, | | Pullulan Replacement C, | |
| Batch 2 | | Batch 2 | |
| Longitude 1 | 13805.5 | Transverse 1 | 14812.6 |
| Longitude 2 | 13470.5 | Transverse 2 | 15514.9 |
| Longitude 3 | 11708.1 | Transverse 3 | 11588.5 |
| Longitude 4 | 12453.2 | Transverse 4 | 14279.2 |
| Average | 12859.3 | Average | 14048.8 |
| S.D. | 959.0 | S.D. | 1486.5 |
| Pullulan Replacement D, | | Pullulan Replacement D, | |
| Batch 1 | | Batch 1 | |
| Longitude 1 | 14662.7 | Transverse 1 | 12821.7 |
| Longitude 2 | 12536.2 | Transverse 2 | 13204.6 |
| Longitude 3 | 11987.5 | Transverse 3 | 14600.1 |
| Longitude 4 | 15107.5 | Transverse 4 | 15138.1 |
| Average | 13573.5 | Average | 13699.3 |
| S.D. | 1541.8 | S.D. | 1696.0 |
| Pullulan Replacement D, | | Pullulan Replacement D, | |
| Batch 2 | | Batch 2 | |
| Longitude 1 | 13452.0 | Transverse 1 | 12624.3 |
| Longitude 2 | 14233.3 | Transverse 2 | 14471.8 |
| Longitude 3 | 12779.6 | Transverse 3 | 15084.6 |
| Longitude 4 | 13578.6 | Transverse 4 | 15563.8 |
| Average | 13510.9 | Average | 14436.1 |
| S.D. | 595.8 | S.D. | 1287.9 |

TABLE 3
Pullulan films dissolution time in minutes. Film dimension = 25
mm × 25 mm.

| | Pullulan | Pullulan | Pullulan |
|---|---|---|---|
| Replication | Control | Replacement C | Replacement D |
| 1 | 3.0 | 2.8 | 2.7 |
| 2 | 2.0 | 2.9 | 3.6 |
| 3 | 3.0 | 3.3 | 2.0 |
| 4 | 3.8 | 2.8 | 1.6 |
| 5 | 2.9 | 3.1 | 2.1 |
| Average | 2.9 | 3.0 | 2.4 |

TABLE 4
Sensory attributes of pullulan replacement films tested against pullulan.
A score of 0 indicates the same sensory attributes as the control.

| Attribute | Pullulan Replacement C | Pullulan Replacement D |
|---|---|---|
| Thickness | 0.18 | −0.45 |
| Mouth Coating | 0.18 | −0.27 |
| Taste | −1 | −1 |
| Disintegration | −0.55 | 0.36 |

TABLE 5
Viscosity of pullulan and pullulan replacements at 25% concentration.

| | Viscosity, cP |
|---|---|
| Pullulan | 18050 |
| Replacement A | 18050 |
| Replacement B | 17600 |

1. A material comprising:
a main film forming material comprising from about 50% to about 98% of a gum polysaccharide and;
from about 1.5% to about 60% of one or more soluble fillers, standardizing or texture altering ingredients;
wherein the material is configured such that its viscosity, tensile strength, dissolution, and sensory attributes are similar to pullulan.

2. The material of claim 1, wherein the gum is one of a low viscosity cellulose gum, methylcellulose, hydroxypropylmethylcellulose or other cellulose derivatives, low viscosity guar gum, alginate, propylene glycol alginate, xanthan gum, pectin, carrageenan, starch or a blend or combination thereof.

3. The material of claim 1, wherein the filler, standardizing, or texture altering ingredients comprises of one or more of a sugar or sugar equivalent caloric ingredient such as a monosaccharide, disaccharide, oligosaccharide, dextrin, starch hydrolyzate, or a blend or combination thereof.

4. The material of claim 1, wherein one or more of the tensile strength, clarity, solubility, texture, sensory attributes, oxygen impermeability, edibility, biodegradability, water solubility, or viscosity is similar to that of pullulan.

5. The material of claim 1, wherein the material is incorporated into a final product such that the solubility of the final product is similar to, or improved upon, the solubility of the same final product containing pullulan.

6. A material comprising
a main film forming material comprising from about 50% to about 98% of a gum polysaccharide and;
from about 1.5% to about 60% of one or more sugar-free soluble fillers, standardizing, or texture altering ingredients;
wherein the film is configured such that its viscosity, tensile strength, dissolution, and sensory attributes are similar to pullulan.

7. The material of claim 6, wherein the gum comprises one or more of a low viscosity cellulose gum, methylcellulose, hydroxypropylmethylcellulose or other cellulose derivatives, low viscosity guar gum, alginate, propylene glycol alginate, xanthan gum, pectin, carrageenan, resistant starch, or a blend or combination thereof.

8. The material of claim 6, wherein the filler, standardizing, or texture altering ingredient comprises one or more of a sugar-free ingredient such as a sugar alcohol, a low viscosity gum, or a blend or combination thereof.

9. The material of claim 8 wherein the sugar alcohol comprises one or more of maltitol, sorbitol, xylitol, mannitol, erythritol, or a blend or combination thereof.

10. The material of claim 8, wherein the low viscosity gum comprises one or more of gum arabic, inulin, arabinoxylan, hyrdolyzed guar, resistant maltodextrins, larch, or a blend or combination thereof.

11. The material of claim 6, wherein one or more of the tensile strength, clarity, solubility, texture, sensory attributes, oxygen impermeability, edibility, biodegradability, water solubility, or viscosity is similar to that of pullulan.

12. The material of claim 6, wherein the material is incorporated into a final product such that the solubility of the final product is similar to the solubility of the same final product containing pullulan.

13. A material comprising:
a main film forming material comprising from about 1.5% to about 60% of a gum polysaccharide and;
from about 15% to about 75% of one or more soluble fillers or texture altering ingredients;
wherein the material is configured to have strength similar to that of the pullulan.

14. The material of claim 13 wherein the gum polysaccharide is chosen from the list of cellulose gum, methylcellulose, other cellulose derivatives, alginate, propylene glycol alginate, xanthan gum, pectin, carrageenan, starch or a blend or combination thereof.

15. The material of claim 13 wherein the one or more soluble fillers or texture altering ingredients is chosen from the list of monosaccharides, disaccharides, oligosaccharides, dextrins, low viscosity gums such as gum arabic, inulin, larch, or a blend or combination thereof.

16. The material of claim 1, comprising about 96% of a hydroxypropylmethylcellulose, about 3% of carboxymethylcellulose, and about 1% of a dextrin.

17. The material of claim 6, comprising about 94% of hydroxypropylmethylcellulose, about 1% of carboxymethylcellulose, and about 5% of a low viscosity guar.

18. The material of claim 1, further comprising an anti-foaming ingredient.

19. The material of claim 6, further comprising an anti-foaming ingredient.

20. The material of claim 13, further comprising an anti-foaming ingredient.
